(19) United States
(12) Patent Application Publication
(10) Pub. No.: US 2019/0120966 A1
(43) Pub. Date: Apr. 25, 2019

(54) DEPTH MAP MEASURING DEVICE AND DEPTH MAP MEASURING METHOD

(71) Applicant: Hitachi-LG Data Storage, Inc., Tokyo (JP)

(72) Inventors: Katsuhiko KIMURA, Tokyo (JP); Kazuhiro TODORI, Tokyo (JP); Naoya MATSUURA, Tokyo (JP)

(21) Appl. No.: 16/142,266

(22) Filed: Sep. 26, 2018

(30) Foreign Application Priority Data
Oct. 20, 2017 (JP) 2017-203096

(51) Int. Cl. G01S 17/89; G01S 7/481

(52) U.S. Cl. CPC G01S 17/89; G01S 7/4817

(57) ABSTRACT

In a depth map measuring device which measures a distance up to an object body, there is provided a light source unit which emits light toward the object body, a light receiving unit which receives a reflected light from the object body, a sensor unit which includes the light source unit and the light receiving unit, and a housing which stores the sensor unit. A rotation axis is set to a direction perpendicular to a center axis of the light emitted from the light source unit. The sensor unit is held in the housing in a state of varying in angle about the rotation axis. A disk radiation fin is provided around the sensor unit other than a light emitting surface of the light source unit and a light receiving surface of the light receiving unit.

### CROSS-REFERENCE TO RELATED APPLICATION

The present application claims priority from Japanese application JP 2017-203096, filed on Oct. 20, 2017, the contents of which is hereby incorporated by reference into this application.

### BACKGROUND OF THE INVENTION

### 1. Field of the Invention

The present invention relates to a depth map measuring device and a depth map measuring method.

### 2. Description of the Related Art

In recent years, there are known various devices for measuring a distance up to an object body. Among the devices, a depth map measuring device emits light to the object body by a light source unit, detects a reflected light from the object body to measure a distance up to the object body by a light receiving unit, and outputs a depth map on the basis of a result of measuring a plurality of places of the object body.

Herein, the light source unit is a heat generator which radiates heat for optical emission. Therefore, a member is disposed to thermally conduct the heat of the light source unit, the heat generated by the light source is radiated to the outside through the member. In this way, a rise in temperature of the light source unit can be suppressed by radiating the heat generated by the light source unit. Such a technique is disclosed in JP 2015-206590 A.

### SUMMARY OF THE INVENTION

Herein, in the depth map measuring device, a light source unit is required to vary in angle with respect to the housing. This is because the light emitted from the light source unit is restricted within a certain divergence angle, and thus a setting angle of the light emitted from the depth map measuring device may be changed depending on an installation position of an image measuring device or a distance up to the object body of a detection target. In particular, the angle is necessarily changed in a case where the depth map measuring device is installed in a ceiling in the interior to measure a region in an inclined downward direction to detect a person on a floor.

In addition, in the depth map measuring device, an emission amount of the light source is increased, and a plurality of light sources are installed in order to improve a measurement accuracy. Therefore, heat radiation of the light source unit tends to increase. If the temperature of the light source unit becomes higher than an acceptable value as the heat radiation increases, a light output is lowered and an emission wavelength varies. Therefore, there is a concern that the measurement accuracy is lowered. Therefore, there is a need to effectively radiate the heat of the light source unit to suppress a rise in temperature of the light source unit.

In the related art, there is no consideration for that the light emitted from the light source unit varies in angle with respect to the housing. In a case where the angle of the light emitted from the light source unit varies, a radiation effect of the radiation body is lowered.

An object of the invention is to provide a depth map measuring device and a depth map measuring method which can effectively radiate the heat of the light source unit even in a case where the emission angle of the light source unit varies.

To achieve the above object, the present invention configured a depth map measuring device to measure a distance up to each point of an object body in an image, the depth map measuring device including: a sensor unit; and a housing which holds the sensor unit, wherein the sensor unit includes a light source unit which emits light toward the object body, and a light receiving unit which receives a reflected light from the object body, the sensor unit is held in the housing to vary in angle about a predetermined rotation axis, the light source unit emits light in a direction different from the rotation axis, and a plurality of flat radiation fins are provided in the sensor unit to be rotatably together with the sensor unit, aligned in a rotation direction.

Alternatively, in a depth map measuring device which measures a distance up to an object body, there is provided a light source unit which emits light toward the object body, a light receiving unit which receives a reflected light from the object body, a sensor unit which includes the light source unit and the light receiving unit, and a housing which stores the sensor unit. A rotation axis is set to a direction perpendicular to a center axis of the light emitted from the light source unit. The sensor unit is held in the housing in a state of varying in angle about the rotation axis. A disk radiation fin is provided around the sensor unit other than a light emitting surface of the light source unit and a light receiving surface of the light receiving unit.

According to the invention, it is possible to suppress a temperature of the light source unit with a configuration that the angle of the light emitted from the light source unit varies with respect to the housing.

### BRIEF DESCRIPTION OF THE DRAWINGS

FIG. 1 is a perspective view illustrating a depth map measuring device according to a first embodiment of the invention when viewed from the lower side;

FIG. 2 is a top view of the depth map measuring device according to the first embodiment of the invention;

FIG. 3 is a cross-sectional view of the depth map measuring device according to the first embodiment of the invention;

FIG. 4 is a diagram illustrating an application of the depth map measuring device according to the first embodiment of the invention;

FIG. 5 is a diagram illustrating an example of an angle of a sensor unit in the depth map measuring device according to the first embodiment of the invention;

FIG. 6 is a diagram illustrating another example of the angle of the sensor unit in the depth map measuring device according to the first embodiment of the invention;

FIG. 7 is a perspective view illustrating a depth map measuring device according to a second embodiment of the invention when viewed from the lower side;

FIG. 8 is a perspective view illustrating a depth map measuring device according to a third embodiment of the invention when viewed from the upper side; and

FIG. 9 is a perspective view illustrating a depth map measuring device according to the third embodiment of the invention when viewed from the lower side.

### DESCRIPTION OF THE PREFERRED EMBODIMENTS

Hereinafter, embodiments of the invention will be described using the drawings.

### First Embodiment

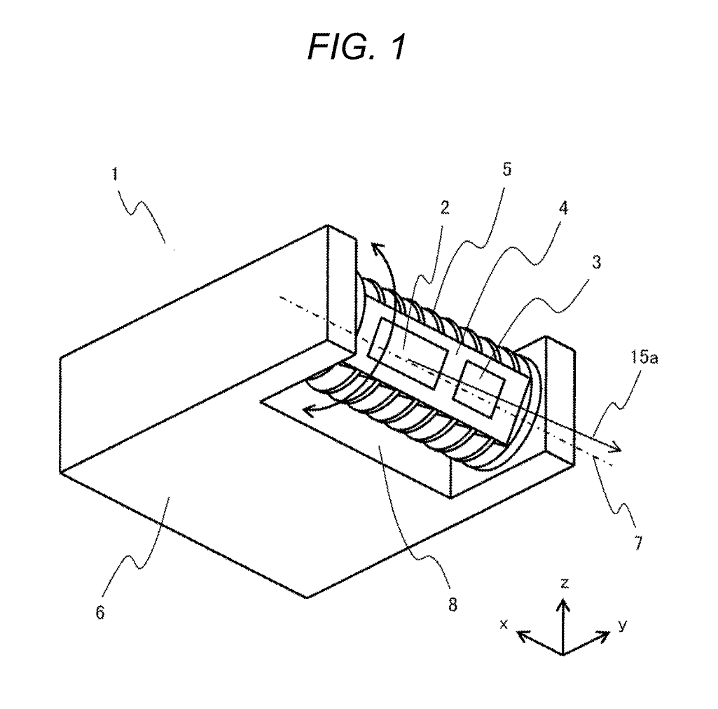

A depth map measuring device 1 according to a first embodiment of the invention will be described using FIGS. 1 to 6.

FIG. 1 is a perspective view illustrating the depth map measuring device 1 of the embodiment. The depth map measuring device 1 includes a light source unit 2 which emits light to an object body to be measured, a light receiving unit 3 which receives a reflected light from the object body, a sensor unit 4 which includes the light source unit 2 and the light receiving unit 3, and a housing 6.

In the embodiment, a horizontal surface is set to an xy plane, a vertical direction is set to a z axis, and an axis in an xy plane perpendicular to a center axis 15a of the light emitted from the light source unit 2 is set to an x axis. Therefore, a y axis is a direction of the light emitting in a case where the center axis 15a of the light emitted from the light source unit 2 is in parallel with the xy plane.

Herein, the measuring operation of the depth map measuring device 1 will be described. The depth map measuring device 1 emits light two-dimensionally widening as the light emitted from the light source unit 2, and measures a distance from a time taken for the light to travel up to an object body 31 (illustrated in FIG. 4) using an image pickup element. Distances of the respective coordinates of the object body 31 are measured, and a distance image is acquired a distance image.

Alternatively, as alternative technology, the depth map measuring device 1 emits a laser beam as the light emitted from the light source unit 2, and measures the distance from a time taken for the laser beam to travel up to the object body 31. The light source unit 2 emits the laser beam in an upward and downward direction and a right and left direction of the object body 31 to measure a distance at each emitting angle, so that the distance at each coordinate (emitting angle) is measured and the distance image in the object body is acquired.

As for the measuring of the distance up to the object body 31, for example, a difference of the angles of visibility from both cameras of a stereo camera may be measured instead of measuring the time taken up to the object body 31.

A measurement result of the depth map measuring device 1 is displayed as a two-dimensional image in a display unit (not illustrated).

Disk radiation fins 5 are provided around the sensor unit 4 besides a light emitting surface of the light source unit 2 and a light receiving surface of the light receiving unit 3. A direction which is vertical to the center axis 15a of the light emitted from the light source unit 2 and in parallel to the horizontal surface (parallel to the x axis) is used as a rotation axis 7. The sensor unit 4 is held in the housing 6 in a state that the angle about the rotation axis 7 is adjustable. A fin surface of the radiation fin 5 is provided in a plane perpendicular to the rotation axis 7.

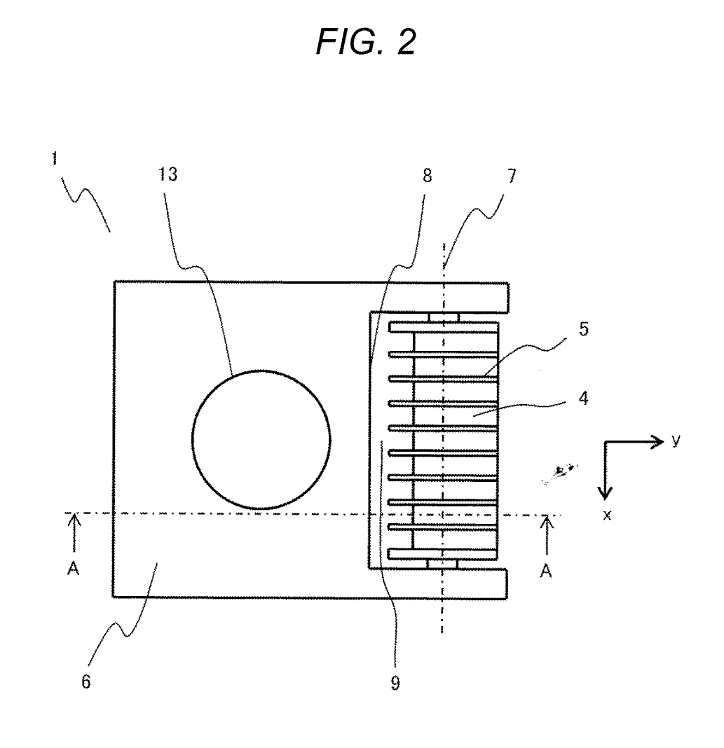

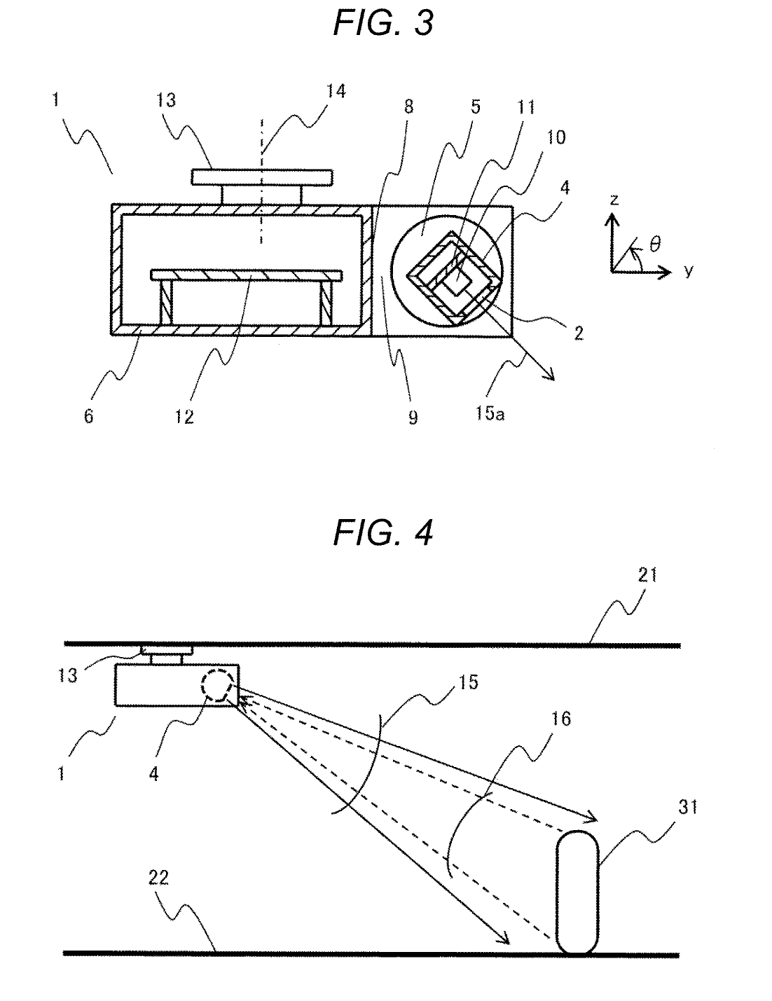

FIG. 2 is a top view of the depth map measuring device 1. FIG. 3 is a cross-sectional view taken along line A-A of the depth map measuring device 1 in FIG. 2. The disk radiation fin 5 provided in the sensor unit 4 is disposed with a gap 9 which is formed with respect to a side surface 8 of the housing 6 facing the sensor unit 4 and on the opposite side to the light emitting surface of the light source unit 2.

In FIG. 3, an angle from the y axis in a yz plane is set to θ as an adjustment angle of the sensor unit 4 (the light source unit 2). In the light source unit 2, there is disposed a light source 10 which is attached to a light source mounting board 11. The light source 10 is driven to emit the light by the light source mounting board 11. FIG. 3 illustrates a case where an angle of an irradiation light from the light source unit 2 is inclined in a downward direction.

The sensor unit 4 may be held to the rotation axis 7 so as to be manually changed in angle with respect to the housing 6, or may be configured using power of a motor based on an instruction of a rotation angle.

In the housing 6, there is provided a circuit board 12. The circuit board 12 includes a control circuit of light emitting timing of the light source 10, a calculation circuit which obtains the distance up to the object body by a reception signal of the light receiving unit 3, and an image processing circuit which generates an image of the object body from the calculated distance data.

On the housing 6, there is provided a fixing portion 13 which attaches the housing 6 to an external member such as a ceiling. The housing 6 is configured to be adjusted to be angled around a center axis 14 which is in parallel to the vertical direction of the fixing portion 13.

FIG. 4 is a diagram illustrating an application of the depth map measuring device 1. Herein, there is illustrated a case where the depth map measuring device 1 is installed in an interior. The depth map measuring device 1 is attached to a ceiling 21 by a screw through the fixing portion 13. An irradiation light 15 from the light source unit 2 provided in the sensor unit 4 is emitted with a certain divergence angle in a downwardly inclined direction to the object body 31 which exists on a floor 22. A reflected light 16 from the object body 31 is incident on the light receiving unit 3 which is provided in the sensor unit 4. In the embodiment, a distance up to the object body 31 is measured on the basis of a time taken until the light is emitted by the light source unit 2 and incident to the light receiving unit 3.

Since the divergence angle of the irradiation light 15 from the light source unit 2 is finite, a measurable range of the distance of the object body 31 is also restricted. Therefore, there is a need to change the angle of the light emitted from the depth map measuring device 1 to the object body 31 according to a height of the ceiling 21 where the depth map measuring device 1 is installed, or direction and distance up to the object body 31 which is a measuring target.

In the embodiment, a direction in parallel to the horizontal surface which is perpendicular to the center axis 15a of the irradiation light from the light source unit 2 is set to the rotation axis 7. With the configuration of the sensor unit 4 which can adjust an angle about the rotation axis 7, the posture of the sensor unit 4 can be set at a desired irradiation angle with respect to the position of the object body 31 even after the depth map measuring device 1 is attached to the ceiling 21. In addition, the housing 6 can be adjusted in angle about the center axis 14 which is in parallel to the vertical direction of the fixing portion 13. Even after the depth map measuring device 1 is attached to the ceiling 21, the posture of the depth map measuring device 1 can be set in a state where the measurement can be made with respect to a wide azimuth angle.

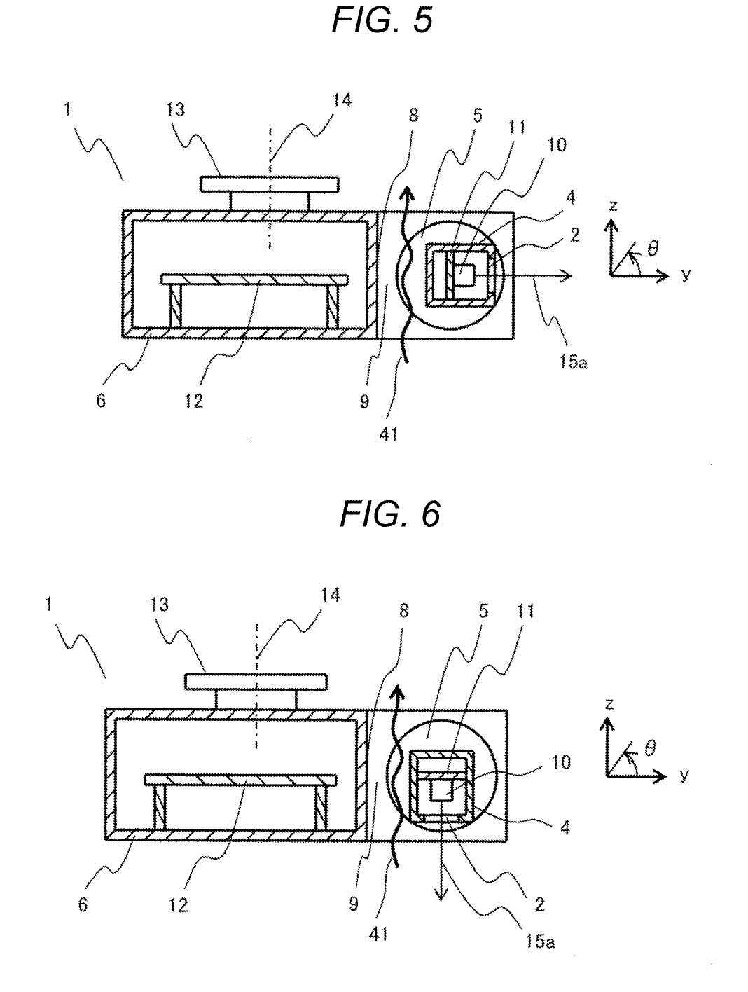

The effect of the disk radiation fin 5 provided in the sensor unit 4 will be described using FIGS. 5 and 6. FIG. 5 is a diagram illustrating a case where the light is emitted from the light source unit 2 in a horizontal direction (a case where the angle θ with respect to the y axis of the center axis 15a of the irradiation light from the light source unit 2 is 0 degree) as an example of an angle of the sensor unit 4 in the depth map measuring device 1. FIG. 6 is a diagram illustrating a case where the light is emitted vertically downward from the light source unit 2 (a case where the angle θ with respect to the y axis of the center axis 15a of the irradiation light is −90 degrees) as another example of the angle of the sensor unit 4.

In the embodiment, the radiation fin 5 provided around the sensor unit 4 other than the light emitting surface of the light source unit 2 and the light receiving surface of the light receiving unit 3 is formed in a disk shape. With the side surface 8 of the housing 6 facing the sensor unit 4 and the gap 9 with respect to an edge portion of the radiation fin 5, the side surface 8 of the housing 6 and the edge portion of the radiation fin 5 do not come into contact to each other even in a case where the angle of the sensor unit 4 is changed about the rotation axis 7. In this sense, even if the radiation fin 5 is not formed in a right circle, a projection may be modified to partially contain an elliptical shape or a slightly angled shape as long as the edge portion of the radiation fin 5 does not come into contact. With the configuration, since the radiation fin 5 always exists in the gap 9 regardless of the angle of the sensor unit 4, heat transferring from the light source unit 2 to the radiation fin 5 is radiated to the air flowing in the gap 9. Further, since disposing the rotation axis 7 of the sensor unit 4 is disposed to be in parallel to the horizontal surface, the heat transferred to the radiation fin 5 can be efficiently radiated by a natural convection 41 flowing in the gap 9 vertically upward.

In this sense, if the heat of the radiation fin 5 is radiated by the natural convection 41, the radiation fin 5 may be modified to be configured to extend in a direction which is slightly inclined with respect to the yz plane and partially contains a component of a gravitational direction. In addition, in a modification where the rotation axis of the sensor unit 4 is disposed to be inclined from the xy plane (horizontal surface), it is possible to make a configuration such that the heat of the radiation fin 5 is radiated by the natural convection 41 by forming the radiation fin 5 in an approximate gravitational direction.

With the above configuration, it is possible to realize a depth map measuring device which can suppress a rise in temperature of the light source unit even in a case where the angle of the light emitted from the light source unit is changed in the configuration that the angle of the light emitted from the light source unit varies with respect to the housing.

### Second Embodiment

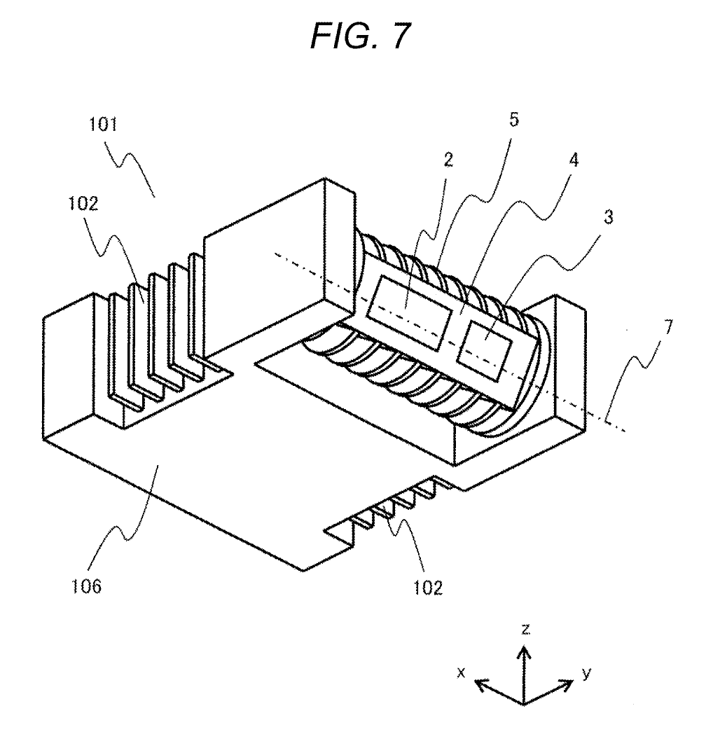

Next, a depth map measuring device 101 according to a second embodiment of the invention will be described using FIG. 7. Further, the components common to those of the first embodiment in the following embodiment will be attached with the same symbol as that of the first embodiment, and the detailed description will be omitted.

FIG. 7 is a perspective view of the depth map measuring device 101 of the embodiment when viewed from the lower side. A difference from the first embodiment is that a fin 102 is formed in the side surface of a housing 106 along the vertical direction. The other configurations are the same as those described in the first embodiment. The same configurations as those of the first embodiment are that the posture of the sensor unit 4 can be set about the rotation axis 7 which is vertical to the center axis of the irradiation light from the light source unit 2 and in parallel to the horizontal surface, that the posture of the depth map measuring device 101 can be set about the vertical direction, and that the radiation effect of the natural convection can be obtained by the disk radiation fin 5 provided in the sensor unit 4 regardless of the angle of the light emitted from the light source unit 2.

In the embodiment, with the fin 102 in the side surface of the housing 106, the surface area of the housing 106 can be expanded, and the radiation performance of the heat transferred from the circuit board 12 (which is provided in the housing 106 while not illustrated in FIG. 7) to the housing 106 can be increased. In addition, the heat generated by the light source unit 2 can be transferred from the sensor unit 4 to the housing 106, and the effect of radiating the heat from the housing 106 can be increased. Further, since the fin 102 is disposed along the vertical direction, the radiation can be efficiently performed by the natural convection flowing vertically upward.

With the above configuration, it is possible to realize a depth map measuring device which can more suppress a rise in temperature of the light source unit.

### Third Embodiment

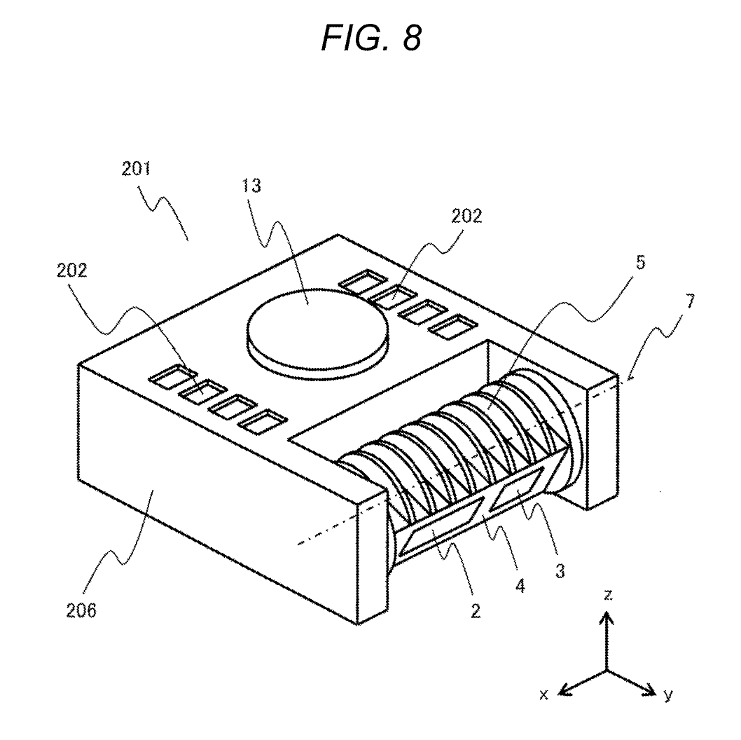

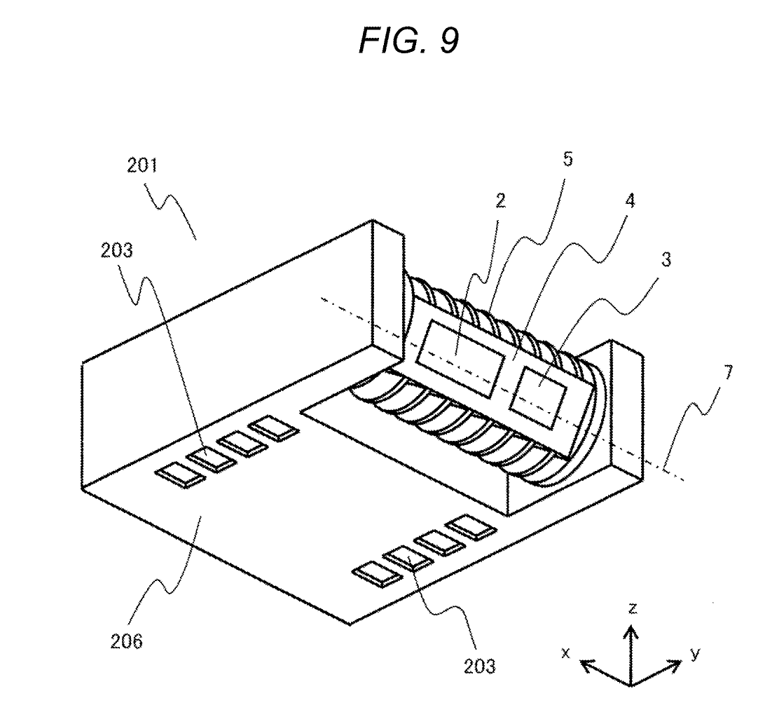

Next, a depth map measuring device 201 according to a third embodiment of the invention will be described using FIGS. 8 and 9.

FIG. 8 is a perspective view of the depth map measuring device 201 of the embodiment when viewed from the upper side. FIG. 9 is a perspective view of the depth map measuring device 201 when viewed from the lower side. A difference from the first embodiment is that an upper opening 202 is provided in the upper surface of a housing 206, and a lower opening 203 is provided in the bottom surface of the housing 206. The upper opening 202 and the lower opening 203 of the housing 206 are provided at positions projected along the vertical direction.

The other configurations are the same as those described in the first embodiment. The same configurations as those of the first embodiment are that the posture of the sensor unit 4 can be set about the rotation axis 7 which is vertical to the center axis of the irradiation light from the light source unit 2 and in parallel to the horizontal surface, that the posture of the depth map measuring device 101 can be set about the vertical direction, and that the radiation effect of the natural convection can be obtained by the disk radiation fin 5 provided in the sensor unit 4 regardless of the angle of the light emitted from the light source unit 2.

In the embodiment, with the upper opening 202 and the lower opening 203 provided in the housing 206, the heat of the circuit board 12 (which is provided in the housing 206 while not illustrated in FIGS. 8 and 9) can be efficiently radiated by the natural convection flowing through the lower opening 203 and the upper opening 202 toward the lower side and the upper side of the housing 206. In addition, the heat generated in the light source unit 2 can be transferred from the sensor unit 4 to the housing 206, and the effect of radiating the heat from the housing 206 can be increased.

With the above configuration, it is possible to realize a depth map measuring device which can more suppress a rise in temperature of the light source unit.

Further, the invention is not limited to the above embodiments, and various modifications can be made. For example, the embodiments are described in a clearly understandable way for the invention, and thus the invention is not necessarily to be provided with all the configurations described above. In addition, some configurations of a certain embodiment can be replaced with the configurations of other embodiments. In addition, it is also possible to add the configurations of the other embodiments to those of a certain embodiment. Furthermore, additions, omissions, and substitutions may be made on some configurations of each embodiment using other configurations.

What is claimed is:

1. A depth map measuring device which measures a distance up to each point of an object body in an image, comprising:
a sensor unit; and
a housing which holds the sensor unit, wherein
the sensor unit includes a light source unit which emits light toward the object body, and a light receiving unit which receives a reflected light from the object body,
the sensor unit is held in the housing to vary in angle about a predetermined rotation axis,
the light source unit emits light in a direction different from the rotation axis, and
a plurality of flat radiation fins are provided in the sensor unit to be rotatably together with the sensor unit, aligned in a rotation direction.

2. The depth map measuring device according to claim 1, wherein
the radiation fin is formed in a disk shape, and provided around the sensor unit other than a light emitting surface of the light source unit and a light receiving surface of the light receiving unit.

3. The depth map measuring device according to claim 1, wherein
a fin surface of the radiation fin is provided in a surface perpendicular to the rotation axis.

4. The depth map measuring device according to claim 1, wherein
the radiation fin is disposed with a gap with respect to a side surface of the housing facing the sensor unit.

5. The depth map measuring device according to claim 1, wherein
the rotation axis is set to a direction which is perpendicular to a center axis of the light emitted from the light source unit and in parallel to a horizontal surface, and
the sensor unit is held in the housing in a state of varying in angle about the rotation axis.

6. The depth map measuring device according to claim 5, wherein
a fin surface of the radiation fin is provided in a surface perpendicular to the rotation axis.

7. The depth map measuring device according to claim 5, wherein
the radiation fin is disposed with a gap with respect to a side surface of the housing facing the sensor unit.

8. The depth map measuring device according to claim 5, wherein
a fin is provided in a side surface of the housing along a vertical direction.

9. The depth map measuring device according to claim 5, wherein
an upper opening is provided in an upper surface of the housing,
a lower opening is provided in a bottom surface of the housing, and
the upper opening and the lower opening are provided at positions which are projected along a vertical direction.

10. The depth map measuring device according to claim 1, wherein
the rotation axis is set to a direction which is perpendicular to a center axis of the light emitted from the light source unit and in parallel to a horizontal surface,
the sensor unit is held in the housing in a state of varying in angle about the rotation axis,
a fixing portion is provided in an upper portion of the housing to attach the housing to an external member, and
the housing varies in angle about a center axis which is in parallel to a vertical direction of the fixing portion.

11. A depth map measuring method of radiating heat of a sensor unit by a plurality of flat radiation fins which are aligned in a rotation direction of the sensor unit and rotate together with the sensor unit,
the depth map measuring method, comprising:
holding the sensor unit in a housing to vary in angle about a predetermined rotation axis;
emitting light from a light source unit of the sensor unit in a direction different from the rotation axis;
receiving a reflected light from an object body by a light receiving unit of the sensor unit; and
measuring a distance up to each point of the object body in an image.
